(19) United States
(12) Patent Application Publication
(10) Pub. No.: US 2026/0093688 A1
(43) Pub. Date: Apr. 2, 2026

(54) INCREMENTAL TASK PERFORMANCE USING A STRUCTURED MEMORY

(71) Applicant: GDM Holding LLC, Mountain View, CA (US)

(72) Inventors: Nicholas Brady Garvan Monath, Cambridge, MA (US); James Bradley Wendt, San Francisco, CA (US); Beliz Gunel, San Francisco, CA (US); Sandeep Tata, San Francisco, CA (US); Dulhan Hansaja Jayalath, Sunnyvale, CA (US)

(21) Appl. No.: 19/347,584

(22) Filed: Oct. 1, 2025

Related U.S. Application Data
(60) Provisional application No. 63/702,128, filed on Oct. 1, 2024.

(51) Int. Cl. G06F 16/242

(52) U.S. Cl. CPC G06F 16/2425; G06F 16/2423

(57) ABSTRACT

Methods, systems, and apparatus, including computer programs encoded on a computer storage medium, for performing a task. In one aspect, a method comprises: receiving a query for an incremental task to be performed on a content item comprising a sequence of content chunks; initializing a structured memory that represents data according to a schema; and performing a respective memory update iteration for each content chunk in the sequence, each memory update iteration comprising: processing an input for the memory update iteration comprising (i) the query, (ii) data specifying the schema, (iii) the structured memory as of the updating iteration, and (iv) the content chunk using a generative neural network to generate a proposed memory update; and updating the structured memory using the proposed memory update; and after performing the respective memory update iterations for the content chunks in the sequence, generating a response to the query using the structured memory.

### CROSS-REFERENCE TO RELATED APPLICATIONS

This application claims the benefit of priority to U.S. Application No. 63/702,128, filed on Oct. 1, 2024, the contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can use a machine learning model to perform incremental tasks using a structured memory.

The machine learning model can be a generative model that processes a query for an incremental task and generates a response to the query based on context data relevant to the task (e.g., text documents, audio files, videos, images, etc.) that are divided into context data chunks.

The incremental task can be, for example, a summarization task e.g., generating a live summary of an audio file where the audio file is broken into intervals, generating a summary based on a text document where the document is divided into pages, generating a summary based on a video that is divided into scenes, generating a summary based on an image that is divided into segments, generating a summary of online search results as new documents appear online.

As another example, the incremental task can be an image or video generation task e.g., generating an image or a video based on a document that is divided into paragraphs, generating an image based on an audio file that is divided into intervals, etc.

As another example, the incremental task can be a retrieval task e.g., a code retrieval task where the code is divided into code segments.

At each of a series of memory update iterations, the system can update a response to a query for the task based on a new context data chunk. The system can use a structured memory to track information from previous memory update iterations and include information from the new context data chunk that is relevant to the task.

The structured memory can represent data according to a schema. The schema specifies a set of possible keys and, optionally, requirements for the values for some or all of the keys. As a result, the structured memory is a set of key value pairs with each key being one of the keys from the schema. At each memory update iteration, the system can do one or more of: adding a new key value pair to the schema or modifying a value for an existing key value pair.

In one aspect, there is provided a method performed by one or more computers, the method comprising: receiving a query for an incremental task to be performed on a content item comprising a sequence of content chunks; initializing a structured memory that represents data according to a schema; and performing a respective memory update iteration for each content chunk in the sequence, each memory update iteration comprising: processing an input for the memory update iteration comprising (i) the query, (ii) data specifying the schema, (iii) the structured memory as of the updating iteration, and (iv) the content chunk using a generative neural network to generate a proposed memory update; and updating the structured memory using the proposed memory update; and after performing the respective memory update iterations for the content chunks in the sequence, generating a response to the query using the structured memory.

That is, the system can, at each memory update iteration, store keys and values representing the input in a key-value cache. For each attention head of each attention layer of the generative network, the system can access, from the key-value cache, keys and values for the attention head for a largest prefix of the input for the memory update iteration that has a matching prefix in the input for the previous memory update iteration.

In some implementations, the structured memory is ordered before the content chunk in the input. Additionally, the query and the data specifying the schema can be ordered before the structured memory in the input.

In some implementation, updating the structured memory using the proposed memory update comprises replacing a portion of the structured memory with the proposed memory update.

In some implementations, updating the structured memory using the proposed memory update comprises adding the proposed memory update to the structured memory in accordance with the schema.

In some implementations, each memory update iteration comprises storing keys and values representing the input in a key-value cache.

In some implementations, processing an input for the memory update iteration comprises: for each attention head of each attention layer of the generative neural network, accessing, from the key-value cache, keys and values for the attention head for a largest prefix of the input for the memory update iteration that has a matching prefix in the input for a previous memory update iteration.

In some implementations, the largest prefix comprises the query, the data specifying the schema, and a portion of the structured memory after the previous memory update iteration.

In some implementations, each memory update iteration further comprises after updating the structured memory, reordering the structured memory to prioritize data that is least likely to change during subsequent memory update iterations.

In some implementations, the structured memory is ordered before the content chunk in the input.

In some implementations, the query and the data specifying the schema are ordered before the structured memory in the input.

In some implementations, the method further comprises receiving a task instruction characterizing the incremental task.

In some implementations, the input further comprises the task instruction.

In some implementations, the method further comprises generating the data specifying the schema.

In some implementations, generating data specifying the schema comprises: processing an input comprising the query using a second generative neural network to generate the data specifying the schema.

In some implementations, the input comprising the query further comprises one or more examples that each include an example query and data specifying an example memory structure for responding to the example query.

In some implementations, updating the structured memory using the proposed memory update comprises modifying one or more values in the structured memory using the proposed memory update.

In some implementations, updating the structured memory using the proposed memory update comprises adding data specifying the proposed memory update to the end of the structured memory.

In some implementations, the incremental task is a summarization task.

In some implementations, the incremental task is a retrieval task.

In some implementations, generating a response to the query using the structured memory comprises: processing another input comprising the query and the structured memory after performing the respective memory update iterations using a third generative neural network to generate the response to the query.

In some implementations, the third generative neural network is the generative neural network.

In some implementations, the content chunks are text segments.

In some implementations, the content chunks are video segments.

In some implementations, the content chunks are segments of an audio file.

In some implementations, the content chunks are segments of an image.

In some implementations, the content chunks are code segments.

The subject matter described in this specification can be implemented in particular embodiments so as to realize one or more of the following advantages.

The system described in this specification can perform an incremental task where context data is processed in chunks. Conventional methods for performing incremental tasks include, at each of a series of memory update iterations, prompting a generative model with an input that includes a query, a next context chunk, and an output from the previous step that acts as a memory. Conventional methods thus output a new memory at each update iteration. Outputting a new memory at each update iteration has a high computational cost for the generative model in terms of the number of tokens to be decoded for each iteration. As data is added to the memory, the generative neural network will need to output more tokens at each update iteration. Outputting more tokens increases the number of auto-regressive generation steps for the generative neural network. Auto-regressive generation steps can be computationally expensive and incur additional latency.

However, the system described in this specification prompts a generative model with a query, data defining a schema, a structured memory that follows the schema, and a next context chunk and outputs a proposed update to the structured memory at each update iteration. By updating the structured memory, the system can constrain the output of each memory update iteration to include only information that is relevant to the query to update the memory.

Conventional methods for performing incremental tasks are limited by high generation costs. At each memory update iteration, the memory is updated through an overwrite process. In order to reduce generation costs, instead of generating a structured memory to overwrite the prior memory with, the system outputs a proposed memory update which can be an addition to the memory or a replacement of a portion of the memory. By outputting an update to the structured memory rather than the memory itself, the system described in this specification reduces the number of tokens to be decoded by the generative model and thus reduces the generation cost of the generative model.

The performance of conventional methods for performing incremental tasks can be limited by low encoding efficiency. The number of tokens to be encoded increases with the length of the prompt. When the prompt includes a new data chunk and a memory, the size of the new data chunk and the memory can dominate the length of the prompt and sections of the prompt are re-encoded. To increase encoding efficiency, the system utilizes key-value caching to store the prompts to the generative model during each memory update iteration. When a prefix of the prompt matches a prior encoded prompt, the model can reuse the keys and values previously computed for this prefix. The keys and values can be reused for the structured memory until the first change to the structured memory when compared to the previous prompt, which is not possible when using conventional methods where the memory is overwritten during each memory update iteration. This reduces the number of tokens that need to be reencoded by the generative model. When a generative model encodes tokens that represent an input, e.g., including a structured memory, the generative model can need to perform many calculations to encode the tokens for the input. A key-value cache can store intermediate information, e.g., intermediate computation results of attention mechanisms performed by attention layers of the generative model, from encoding previous tokens in previous memory update iterations. Instead of recomputing the same calculations used for encoding previous tokens, the generative model can use the data in the key-value cache when encoding a token in a new input that matches a token in a previous input. The generative model does not need to perform the calculations to reencode the tokens that have been encoded for the previous prompt.

The system uses prompts that are arranged so that the memory appears before the context chunk and so that the query and the data defining the schema are ordered before the memory. The query and the data defining the schema do not change between memory update iterations, thus the system does not need to re-encode the query or the data defining the schema between memory update iterations. In some cases, to maximize the length of the prefix, the system can reorder the structured memory to prioritize data that is least likely to change. For example, the system can process an input that includes the query and the data in the structured memory using a generative neural network, e.g., the same neural network or a different neural network, to generate a prediction of how likely the data is to change at future iterations. As another example, the system can apply one or more heuristics to the data in the structured memory to determine how likely the data in the structured memory is to change.

The system does not need to re-encode the portions of the memory that are a part of the prefix between memory update iteration. By ordering the prompt using some all of the above techniques, the system maximizes the length of the prefix, enabling increased encoding efficiency. Minimizing the portions of prompts that need to be reencoded between memory update iterations saves computational resources without degrading output quality.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example response generation system.

FIG. 2 is a flow diagram of an example process for performing response generation.

FIG. 3 is a flow diagram of an example process for performing a memory update iteration.

FIG. 4 illustrates an example architecture for a response generation system.

FIG. 5 illustrates an example of performing a memory update iteration.

FIG. 6 illustrates an example of performing a memory update iteration for a code composition task.

FIG. 7 illustrates an example comparison between updating a structured memory by modifying values in the structured memory and by adding data to the end of the structured memory.

FIG. 8 shows a table that includes performance metrics for various methods for performing two types of incremental tasks.

Like reference numbers and designations in the various drawings indicate like elements.

### DETAILED DESCRIPTION

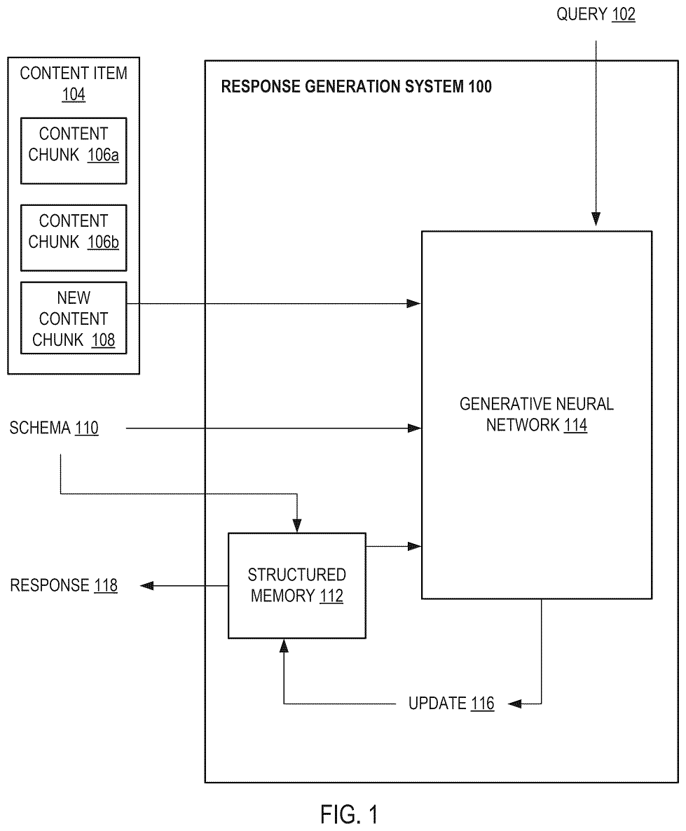

FIG. 1 is a block diagram of an example response generation system. The response generation system 100 is an example of a system implemented as computer programs on one or more computers in one or more locations in which the systems, components, and techniques described below are implemented.

The response generation system 100 includes a structured memory 112 and a generative neural network 114. The response generation system 100 is configured to process a query 102, a content item 104, and data specifying a schema 110 to generate a response 118.

The response generation system 100 can receive a query 102 for a task to be performed. The query 102 can be a query for an incremental task to be performed on a content item 104. The content item 104 can be a content item that is divided into a sequence of content chunks 106a-c. The content chunks 106a-c can be, for example, text segments, video segments, segments of an audio file, patches of an image, code segments, or a combination of these. The sequence of content chunks 106a-c can be ordered by, e.g., the order in which the content chunks appear in the content item 104. The sequence can include any appropriate number of content chunks 106a-c, e.g., 5, 10, 100, 500, 2000, etc.

The incremental task can be, for example, a summarization task e.g., generating a live summary of an audio file where the audio file is broken into intervals, generating a summary based on a text document where the document is divided into pages, generating a summary based on a video that is divided into scenes, generating a summary based on an image that is divided into segments, generating a summary of online search results as new documents appear online.

In some examples, the incremental task can be a generation task. For example, the incremental task can be an image or video generation task e.g., generating an image or a video based on a document that is divided into paragraphs, generating an image based on an audio file that is divided into intervals, etc. For example, the incremental task can be an audio generation task, e.g., generating an audio file based on a document that is divided into paragraphs.

In some examples, the incremental task can be a retrieval task e.g., a code retrieval task where the code is divided into code segments, a document retrieval task where a collection of documents is divided into document chunks, or an audio retrieval task where an audio file is divided into audio segments.

In some examples, the response generation system can receive a task instruction that characterizes the incremental task. The task instruction can provide specific details about the incremental task to be performed. For example, for a summarization task, a task instruction could be “Generate a summary of the provided text, focusing on the main characters and key plot points.” For example, for a retrieval task, a task instruction could be “Find two functions that are relevant to the task.”

The response generation system 100 can initialize a structured memory 112 that represents data according to a schema 110. The structured memory 112 can store information obtained from content chunks 106a-c that have already been processed by the response generation system 100 in a structured manner. At each of a series of memory update iterations, the response generation system can update the structured memory 112 based on a new context data chunk.

The schema 110 can provide a structure for organizing the data within the structured memory 112. The schema 110 can be specified using, for example, a typed hierarchical structure. The typed hierarchical structure can define types and arrangement of data stored within the structured memory 112. For example, a schema for a summarization task can define a structure for character names and the events they are involved in. By adhering to the schema 110, the response generation system 100 can ensure that the structured memory 112 maintains a consistent and relevant format for the incremental task.

The schema 110 can specify a set of possible keys and, optionally, requirements for the values for some or all of the keys. As a result, the structured memory 112 can be a set of key value pairs with each key being one of the keys from the schema 110. The keys can correspond to, for example, categories or topics, and the values can store information relevant to the query for those keys. The requirements can specify data types for the values, e.g., strings, integers, floating point numbers, lists, or a combination of one or more of these.

The response generation system 100 can generate data specifying the schema 110. The data specifying the schema 110 can be a textual description that defines the structure and constraints for the data stored in the structured memory 112. For example, the schema can be generated dynamically based on the received query 102 to tailor the structure of the structured memory 112 to the specific task. The system can utilize a generative model to process the query 102, and optionally task examples, to produce the data that specifies the schema.

For example, the response generation system can process an input, which can include the query 102, using a generative neural network to generate the data specifying the schema 110. In some examples, the input can also include one or more examples, where a given example can include an example query and corresponding data specifying an example memory structure for responding to the example query. Generative neural networks are described in further detail below.

For each content chunk 106a-c in the sequence of content chunks, the response generation system 100 can perform a respective memory update iteration. The memory update iteration can update the structured memory 112 with information from the corresponding content chunk that is relevant to the query 102. By performing an update for each chunk 106a-c in the sequence, the response generation system 100 can handle large content items that might otherwise exceed the processing capacity of the generative neural network 114 in a single step.

The response generation system 100 can process an input for the memory update iteration to generate a proposed memory update 116. The response generation system 100 can update the structured memory using the proposed memory update 116. The input can include the query 102, the data specifying the schema 110, the structured memory 112 as of the updating iteration, and the content chunk 106a-c for the iteration. The content chunk 106a-c for the iteration is the specific segment of the content item 104 being processed during the current memory update iteration.

The structured memory 112 as of the updating iteration can represent the accumulated information relevant to the query from all previously processed content chunks 106a-c. For a first memory update iteration, the structured memory can be empty or contain initial values. In subsequent iterations, the structured memory can reflect cumulative updates from some or all preceding chunks in the sequence.

In some examples, the input can further include the task instruction. The task instruction can provide specific guidance beyond the general goal implied by the query 102. This can allow the response generation system 100 to tailor the updates to meet more detailed requirements, e.g., focusing on particular aspects of the content.

The proposed memory update 116 can be a data structure or command that specifies a modification to the structured memory 112. The modification can take several forms, e.g., adding new information, replacing existing information, or modifying values associated with existing keys within the structured memory 112. The format of the proposed memory update 116 can be constrained by the schema 110 to maintain the integrity and organization of the structured memory 112.

For example, a proposed memory update can specify an operation, a path within the hierarchical structure of the schema, and a value. The path can specify a location within the structured memory 112, such as by using a sequence of keys to navigate the hierarchy. The value can represent the new or updated information to be incorporated into the structured memory. For example, for a summarization task, a proposed memory update 116 can add a new event to a list associated with a specific key. For example, for a retrieval task, a proposed memory update 116 can replace a description associated with a key if more accurate information is found in a subsequent content chunk.

The response generation system can use a generative neural network 114 to generate the proposed memory update 116. A generative neural network can, for example, have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, Noam Shazeer, Adam Roberts, Katherine Lec, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020; Aakanksha Chowdhery, et al. PaLM: Scaling Language Modeling with Pathways, arXiv preprint arXiv: 2204.02311; Rohan Anil, et al. Palm 2 technical report. arXiv preprint arXiv: 2305.10403, 2023; and Gemini Team, et al. Gemini: a family of highly capable multimodal models. arXiv preprint arXiv: 2312.11805 (2023).

As a particular example, the generative neural network 114 can be one of the language model neural networks described in Sparrow (Glaese et al. arXiv: 2209.14375), Chinchilla (Hoffmann et al. arXiv: 2203.15556), and PaLM 2 (Anil, et al. arXiv: 2305:10403). As another particular example, the generative neural network 114 can be one of the vision language model neural networks described in Flamingo (Alayrac et al. arXiv: 2204.14198), PaLI (Chen et al. arXiv: 2209.06794), and PaLI-X (Chen et al. arXiv: 2305.18565). As yet another particular example, the generative neural network 114 can be one of the foundation model neural networks described in Imagen (Saharia et al. arXiv: 2205.11487) and Parti (Yu et al. arXiv: 2206.10789). A foundation model is a large-scale machine learning model trained on a broad data set that can be adapted and fine-tuned for a wide variety of applications and downstream tasks.

Generally, however, the generative neural network includes (i) a sequence of multiple attention layers that each apply an attention mechanism (ii) and an output subnetwork that processes an output of the last attention layer to generate the score distribution. The sequence of multiple attention layers can be arranged in a series, such that each attention layer (except the last) passes its output to the next.

During the processing of a current input sequence, each attention layer in the sequence receives an input vector for at least the last token in the current input sequence. The input vector will also be referred to as “attention layer input vector” or “embedded representation” in this specification.

The attention layer then updates the input vector for at least the last token in the current input sequence at least in part by applying a (learned) function (an “attention mechanism”) to generate an output vector for at least the last token in the current input sequence. The input vector and the output vector typically have the same dimension, i.e., include the same number of vector elements. The output vector will also be referred to as “attention layer output vector” or “updated embedded representation” in this specification. In this specification the term “learned” refers to a function or value that has been adjusted during the training of the system.

The input vector for the first attention layer is an embedding of the last token in the current input sequence that is generated by an embedding layer of the generative neural network, and the input vector for each subsequent attention layer is the output vector generated by the preceding attention layer.

The output subnetwork processes the output vector generated by the last attention layer in the sequence for the last token in the current input sequence to generate the probability distribution. For example, the output subnetwork can include a linear layer followed by a softmax layer. As another example, the output subnetwork can include more layers, e.g., can be a multi-layer perceptron (MLP).

To apply the attention mechanism, each attention layer uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements (and hence a query, a key, a value can also be referred to as a “query vector,” a “key vector,” and a “value vector,” respectively). When there are multiple attention heads, the attention layer then combines the outputs of the multiple attention heads, e.g., by concatenating the outputs and, optionally, processing the concatenated outputs through a linear layer.

A detailed explanation of the attention mechanism is provided below.

The attention mechanism performed by each attention layer generates, for a given input vector x that corresponds to a given token in the current input sequence, e.g., the last token in the current input sequence, a respective query vector q, a respective key vector k, and a respective value vector v.

The given output vector for the given input vector x is computed as a weighted sum of up to N+1 value vectors (where Nis an integer): the value vector for the given input vector x, and the value vectors for the N preceding input vectors (that correspond respectively to the preceding token in the current input sequence).

The N+1 weights (i.e. the weight for value vector for the given input vector x, and the N weights for the value vectors for the N preceding input vectors) may each be computed by a compatibility function e.g. a dot product or scaled dot product, of the query vector for the given input vector x with the (N+1) key vectors corresponding to (N+1) value vectors.

The attention mechanism is configured to apply a self-attention mechanism over the given input vector x; this may be followed by one or more feed-forward neural network layers to generate the given output vector. In general an attention mechanism determines a relationship between two sequences; a self-attention mechanism is configured to relate different positions in the same sequence to determine a transformed version of the sequence as an output. For example the attention layer input may comprise an input vector for each token in the current input sequence. These input vectors provide an input to the self-attention mechanism and are used by the self-attention mechanism to determine a new representation of the same sequence for the attention layer output, which may comprise an output vector for each token in the current input sequence. An output of the self-attention mechanism may be used as the output vector, or it may be processed by one or more feed-forward layers to provide the output vector.

In some implementations the attention mechanism is a self-attention mechanism configured to apply each of a query transformation e.g. defined by a query matrix W^{Q}, a key transformation e.g. defined by a key matrix W^{K}, and a value transformation e.g. defined by a value matrix W^{V}, to the input vector x that corresponds to each token in the current input sequence (e.g. a matrix in which each row is one of the input vectors x that correspond respectively to the tokens in the current input sequence) to derive a respective matrix of query vectors Q=XW^{Q} (e.g. a matrix in which each row is one of the query vectors that correspond respectively to the tokens in the current input sequence), matrix of key vectors K=XW^{K} (e.g. a matrix in which each row is one of the key vectors that correspond respectively to the tokens in the current input sequence), and matrix of value vectors V=XW^{V} (e.g. a matrix in which each row is one of the value vectors that correspond respectively to the tokens in the current input sequence), which are used determine an attended sequence for the output. (Note that in an option, the calculation of Q, K and V may also include adding a constant bias, but that is neglected in this explanation; i.e. the bias is assumed to be zero.) For example the attention mechanism may be a dot product attention mechanism applied by applying each query vector to each key vector to determine respective weights for each value vector, then combining the value vectors using the respective weights to determine the output vector that corresponds to each token in current input sequence. The output vector may be scaled by a scaling factor e.g. by the square root of the dimensions of the queries and keys, to implement scaled dot product attention. Thus, for example, an output of the attention mechanism may be determined as

$$softmax ( \frac{{QK}^{T}}{\sqrt{d}} ) V$$

where d is a dimension of each key vector and each query vector (and typically each value vector). A summation over the value vectors is assumed here, weighted by the values

$$softmax ( \frac{{QK}^{T}}{\sqrt{d}} ) .$$

In another implementation the attention mechanism be comprise an “additive attention” mechanism that computes the compatibility function using a feed-forward network with a hidden layer. As previously mentioned, the output of the attention mechanism may be further processed, within the attention layer, by one or more fully-connected, feed forward neural network layers.

The above detailed explanation of the attention mechanism assumes that there is only a single “attention head” in the attention mechanism for the attention layer. However, alternatively, as noted above there may be multiple attention heads in each attention layer, each using a different matrix W^{Q}, and, optionally, a different respective set of matrices W^{K} and W^{V} (the attention mechanism may be referred to as a “multi-query attention mechanism” when the same set of matrices W^{K} and W^{V} are used by the multiple attention heads). In this case, the attention layer output vector is a concatenation of a respective vector

$$softmax ( \frac{{qK}^{T}}{\sqrt{d}} ) V$$

produced by each of the attention heads.

In practice, to apply the multi-query attention mechanism, the attention layer need only apply the set of matrices W^{K} and W^{V} once to generate the matrix of key vectors and the matrix of value vectors, and the matrix of key vectors and the matrix of value vectors are shared across the multiple attention heads within the attention layer.

When the generative neural network operates auto-regressively to generate the output tokens in the output sequence over a plurality of time steps, the attention layer produces output vectors one-by-one (i.e. one output vector at each time step), based on the last input vector (i.e. the input vector corresponding to the last token in the current input sequence) and the N immediately preceding input vectors (i.e. the input vectors corresponding to the N immediately preceding tokens in the current input sequence).

The system can include or access one or more memory devices. The one or more memory devices can either be or include logical memory devices, or can alternatively be or include physical memory devices. For example, when the system is implemented on a plurality of hardware accelerators, e.g., graphics processing units (“GPUs”), field-programmable gate arrays (“FGPAs”), or application-specific integrated circuits (“ASICs”), including tensor processing units (“TPUs”), the one or more memory devices can include high bandwidth memory (HBM) devices disposed within the hardware accelerators, such that the one or more memory devices are local to or co-located with computing resources of the hardware accelerators.

The one or more memory devices store cached intermediate computation results of the attention mechanisms performed by the attention layers, and possibly the intermediate states of other layers, in the generative neural network. The cached intermediate computation results are used to accelerate both the speed and computational resource efficiency of the inference of the generative neural network.

Such intermediate computation results—which include the respective key vectors k, and optionally, the respective value vectors v, which are generated from the input vectors x that correspond respectively to the tokens in the current input sequence—are saved (cached) in the one or more memory devices so that the inference can be executed faster and more computational resource efficiently because re-generating all of these intermediate computation results at each time step can be avoided.

The generative neural network 114 can store keys and values representing the input in a key-value cache. For each attention head of each attention layer of the generative neural network, the generative neural network 114 can access keys and values for the attention head for a largest prefix of the input for the memory update iteration. The largest prefix can match a prefix in the input for the previous memory update iteration. The prefix can be an initial portion of the input to the generative neural network 114. The largest prefix can include information that is remains unchanged between the input to the generative neural network 114 for previous memory update iteration and the input to the generative neural network for the current memory update iteration. The largest prefix can represent the longest initial portion of the current input that is identical to an initial portion of the input from the preceding memory update iteration. For example, a query and a schema can remain constant among inputs to the generative neural network 114 for all memory update iterations. In some examples, the largest prefix can include the query 102, the data specifying the schema 110, and a portion of the structured memory 112 after a previous memory update iteration.

In some examples, the query 102 and the data specifying the schema 110 are ordered before the structured memory 112 in the input. This ordering can maximize the length of the matching prefix that can be reused from the key-value cache during subsequent memory update iterations. The query and the data specifying the schema can be placed first because they remain constant throughout all iterations for a given incremental task. Placing the structured memory 112 before the content chunk can allow the response generation system 100 to utilize a key-value cache with increased efficiency. The response generation system 100 can reuse previously computed intermediate values, e.g., key and value vectors from attention mechanisms, for any unchanged leading portion of the memory from a previous iteration. For example, if only one key-value pair at the end of the structured memory changes between iterations, the key-value cache for the query, the schema, and the entire unchanged portion of the structured memory can be reused.

In some examples, the structured memory 112 is ordered before the content chunk 106a-c in the input. As the content chunk 106a-c changes for each iteration, the content chunk 106a-c can be ordered at the end of the input. Some portions of the structured memory 112 can remain unchanged for a given input for the memory update iteration. In this way, ordering the structured memory 112 before the content chunk 106a-c can maximize the length of the matching prefix.

At each memory update iteration, the response generation system 100 can update the structured memory 112 using the proposed memory update 116. This update can involve incorporating new information from the current content chunk, refining existing information based on more recent data, or both. The proposed memory update 116 can be validated and revised before it is used to update the structured memory 112 to ensure it conforms to the schema 110.

In some examples, the response generation system 100 can replace or modify a portion of the structured memory with the proposed memory update 116. The response generation system 100 can replace or modify one or more values in the structured memory using the proposed memory update 116. The response generation system 100 can replace or modify a value for an existing key value pair. A value can be updated when, for example, new information from the current content chunk for the memory update iteration is determined to be more accurate or complete. A value can be modified to, for example, refine existing data based on additional context provided by the current content chunk.

Data can be added when new, distinct information that conforms to the schema is identified in the current content chunk. In some examples, the response generation system 100 can add the proposed memory update 116 to the structured memory in accordance with the schema 110. In some examples, the response generation system 100 can add data specifying the proposed memory update 116 to the end of the structured memory 112. The response generation system 100 can add a new key value pair to the schema 110. When a new key is identified in the content chunk 106a-c for the current memory update iteration that is not already present in the schema 110, the proposed memory update 116 can specify both the new key and its associated value.

In some examples, the response generation system 100 can reorder the structured memory 112 after updating the structured memory. The response generation system 100 can reorder the structured memory 112 to prioritize data that is least likely to change during subsequent memory update iterations. For example, the response generation system 100 can apply one or more heuristic operations to the data in the structured memory 112 to determine how likely the data in the structured memory is to change. For example, the heuristic operations can include moving data with numerical values before data with string values under the assumption that numerical data, such as counts or identifiers, is less likely to be revised than descriptive text. This prioritization can maximize the length of the matching prefix that can be reused from the key-value cache during subsequent memory update iterations.

In some examples, the response generation system 100 can add data specifying the proposed memory update to the end of the structured memory 112. The response generation system 100 can append the new information to maintain the existing memory structure. This can maximize the portion of the structured memory 112 that is unchanged from a previous iteration. This can increase the efficiency of key-value caching by extending the reusable matching prefix of the input.

After performing the respective memory update iterations for the content chunks 106a-c in the sequence, the response generation system 100 can generate a response 118 to the query 102. The response 118 can be, for example, a natural language response, a computer code response, an image response, or an audio response. The response can provide, for example, a summary, a retrieved code segment, a generated image, or another form of output that fulfills the incremental task based on the aggregated information.

The response generation system 100 can generate the response 118 using the structured memory 112. The response generation system 100 can generate the response 118 based on the information aggregated in the structured memory 112 over the course of the memory update iterations. For example, for a summarization task the response 118 can be a textual summary generated by processing the structured memory 112. The structured memory can include information about specific entities, events, and time points extracted from the content chunks 106a-c. For example, for a retrieval task, the response 118 can be the name or definition of identified content items that are retrieved from a final state of the structured memory 112.

In some examples, the response generation system 100 can process an updated input that includes the query 102 and the structured memory 112 after performing the respective memory update iterations. The structured memory in the updated input can represent the aggregated information from all content chunks in the sequence. In some examples, the updated input can include an instruction prompt that explains how the structured memory 112 relates to the content item specified by the query 102. The prompt can be a final task instruction that describes using the structured memory to perform the task specified in the query 102. The instruction prompt can be, for example, a text prompt. The response generation system 100 can process the updated input using a response generation generative neural network to generate the response 118 to the query. In some examples, the response generation system 100 can use the same generative neural network, e.g., the generative neural network 114, for generating the data specifying the schema 110, the memory update iterations, and the response generation task.

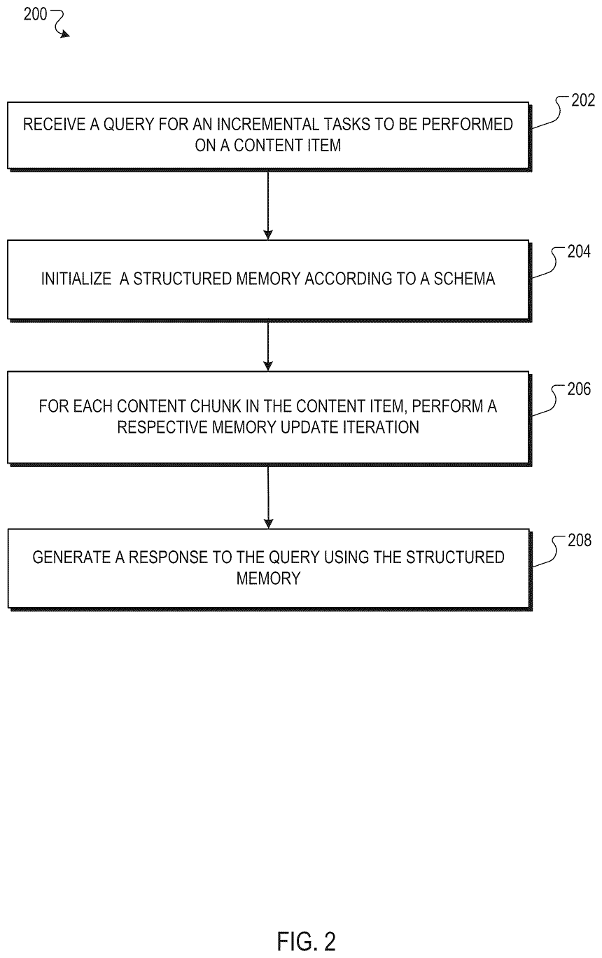

FIG. 2 is a flow diagram of an example process for performing response generation. For convenience, the process 200 will be described as being performed by a system of one or more computers located in one or more locations. For example, a caption generation system, e.g., the response generation system 100 of FIG. 1, appropriately programmed in accordance with this specification, can perform the process 200.

The system can receive a query for an incremental task to be performed on a content item (202). The content item can include a sequence of content chunks. The sequence of content chunks can be ordered by the order in which the content chunks appear in the content item. In some examples, the context chunks can be text segments. In some examples, the context chunks can be video segments. In some examples, the context chunks can be segments of an audio file. In some examples, the context chunks can be segments of an image. In some examples, the context chunks can be code segments.

In some examples, the system can receive a task instruction characterizing the incremental task. In some examples, the incremental task can be a summarization task. In some examples, the incremental task can be a retrieval task. In some examples, the task instruction can specify specific details about the incremental task to be performed.

The system can initialize a structured memory that represents data according to a schema (204). In some implementations, the system can generate the data specifying the schema. The structured memory can store information from processed content chunks in an organized manner according to the schema. The schema defines a structure for the data, for example, by specifying a set of keys and requirements for corresponding values. The schema can be a textual description or blueprint for the structure of data stored in the structured memory. In some implementations, the schema can be generated dynamically based on the received query to tailor the structure of the structured memory to the specific task.

The system can process an input that includes the query using a second generative neural network to generate the data specifying the schema. The input can further include one or more examples. The examples can each include an example query and data specifying an example memory structure for responding to the example query.

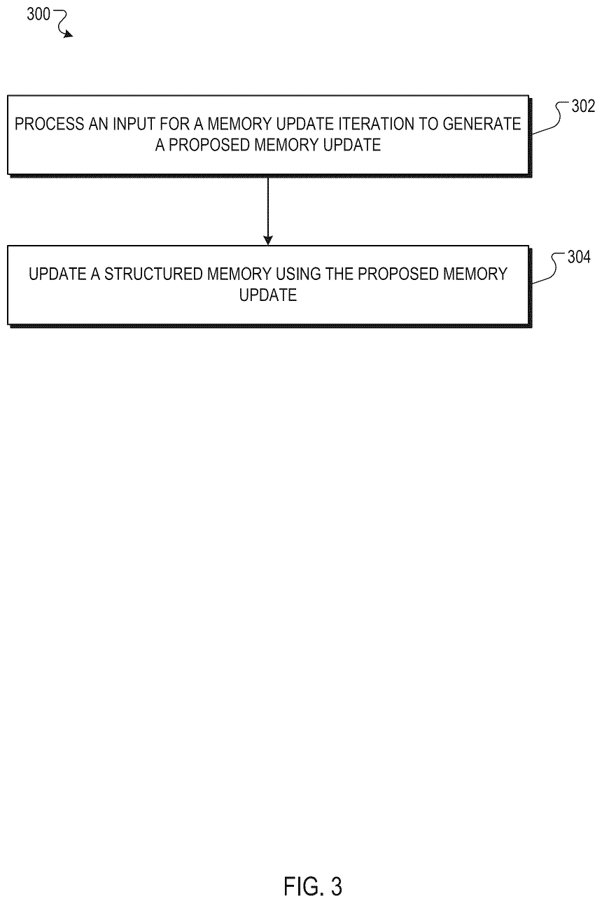

The system can perform a respective memory update iteration for each content chunk in the sequence (206). Performing a respective memory update iteration is described in further detail below with reference to FIG. 3.

After performing the respective memory update iterations for the content chunks in the sequence, the system can generate a response to the query using the structured memory (208). In some implementations, the system can process another input that includes the query and the structured memory after performing the respective memory update iterations using a third generative neural network to generate the response to the query. In some examples, the third generative neural network can be the generative neural network used for the memory update iterations, e.g., the generative neural network 114 of FIG. 1.

The response to the query can be generated based on the information aggregated in the structured memory over the course of all the memory update iterations. The final structured memory can represent the aggregated information from all content chunks in the sequence. For example, the response can be a text segment, a segment of computer code, a generated image, or an audio clip. The generated response can fulfill the task specified in the query.

FIG. 3 is a flow diagram of an example process for performing a memory update iteration. For convenience, the process 300 will be described as being performed by a system of one or more computers located in one or more locations. For example, a caption generation system, e.g., the response generation system 100 of FIG. 1, appropriately programmed in accordance with this specification, can perform the process 300.

The system can process an input for the memory update iteration to generate a proposed memory update (202). The input can include (i) a query, (ii) data specifying a schema, (iii) a structured memory as of the updating iteration, and (iv) a content chunk for the memory update iteration. The system can process the input using a generative neural network. The generative neural network can be a machine learning model that processes an input sequence of tokens to generate an output sequence of tokens.

The query can specify an ultimate goal of an incremental task. The data specifying a schema can determine a structure of a structured memory. The structured memory can store data in an organized manner according to the schema. The content chunk for the memory update iteration can include new content.

In some implementations, the structured memory is ordered before the content chunk in the input. In some implementations, the query and the data specifying the schema are ordered before the structured memory in the input. In some implementations, the input further comprises a task instruction. The task instruction can characterize the incremental task to be performed.

In some implementations, each memory update iteration can include storing keys and values representing the input in a key-value cache. In some examples, processing an input for the memory update iteration can include for each attention head of each attention layer of the generative network, accessing, from the key-value cache, keys and values for the attention head for a largest prefix of the input for the memory update iteration that has a matching prefix in the input for the previous memory update iteration. In some examples, the largest prefix can include the query, the data specifying the schema, and a portion of the structured memory after the previous memory update iteration.

The system can update the structured memory using the proposed memory update (304). The system can replace, modify, or add one or more values to the structured memory based on the proposed memory update.

In some examples, the system can update the structured memory by replacing a portion of the structured memory with the proposed memory update. The system can update the structured memory, for example, when information in a new content chunk is determined to be more complete or accurate. For example, a key-value pair in the structured memory can be overwritten with a new value from the proposed memory update.

In some implementations, the system can modify one or more values in the structured memory using the proposed memory update. Modifying the one or more values can allow for iterative refinement of the stored information as more context becomes available from subsequent content chunks. For example, a value associated with a key can be updated if the proposed memory update provides more accurate or complete information than the data that is currently stored.

In some examples, the system can update the structured memory by adding the proposed memory update to the structured memory in accordance with the schema. The system can add the proposed memory update to the structured memory when information from the current content chunk introduces new concepts or entities that are relevant to the query and need to be added to the structured memory. For example, if the proposed memory update includes a new key-value pair, it can be appended to the existing structured memory.

In some implementations, the system can add data specifying the proposed memory update to the end of the structured memory. Adding the proposed memory update to the end of the structured memory can maximize the length of the matching prefix that is reused from the key-value cache. By appending updates, the system can avoid altering the existing memory structure.

In some implementations, each memory update iteration can further include, after updating the structured memory, reordering the structured memory. The system can reorder the structured memory to prioritize data that is least likely to change during subsequent memory update iterations. For example, the system can apply one or more heuristic operations to the data in the structured memory to determine how likely the data in the structured memory is to change. The heuristic operations can include, for example, moving data with numerical values before data with string values under the assumption that numerical data is less likely to be revised than descriptive text. This prioritization can maximize the length of the matching prefix that can be reused from the key-value cache during subsequent memory update iterations.

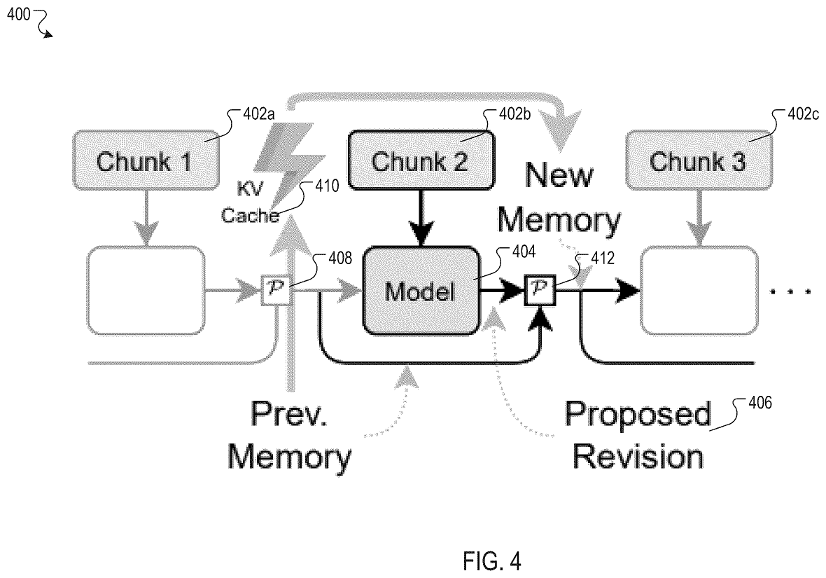

FIG. 4 illustrates an example architecture 400 for a response generation system. The architecture 400 illustrates an iterative process for updating a structured memory by processing a sequence of content chunks.

The architecture 400 includes a generative neural network 404, a previous memory state 408, and an updated memory state 412. The previous memory state 408 can be a structured memory, e.g., the structured memory 112 of FIG. 1 after a previous memory update iteration. The updated memory state 412 can be the structured memory after a current memory update iteration.

A content item, e.g., the content item 104 of FIG. 1 can be divided into three content chunks 402a, 402b, and 402c. The generative neural network 404 can process the content chunks 402a, 402b, 402c sequentially to generate respective proposed memory updates. For the content chunk 402c, the generative neural network 404 can process the previous memory state 408 and the content chunk 402b to generate a proposed revision 406. The generative neural network 404 can be, for example, the generative neural network 114 of FIG. 1. The generative neural network 404 can process the previous memory state 408 and the content chunk 402b to identify information that is relevant to a query, e.g., the query 102 of FIG. 1.

The generative neural network 404 can generate the proposed revision 406 for the content chunk based on content chunks that were previously processed. The proposed revision 406 can be a proposed memory update, e.g., the proposed memory update 116 of FIG. 1. The proposed revision 406 can specify changes to be made to the previous memory state 408. Instead of overwriting the entire memory, the system can generate a targeted update, which can be an addition of new data or a modification or replacement of existing data. The proposed revision 406 can be applied to the previous memory state 408 to generate the updated memory state 412. The updated memory state can incorporate information from the content chunk 402b.

The generative neural network 404 can use a key-value cache 410 to increase encoding efficiency during the iterative process. For each memory update iteration, the generative neural network 404 can store keys and values that represent the input for that iteration in the key-value cache 410. In subsequent iterations, for any prefix of the new input that matches a previously processed input, the generative neural network 404 can reuse the stored keys and values from the key-value cache 410. Reusing cached data can reduce the number of tokens that need to be re-encoded in each step, which can save computational resources.

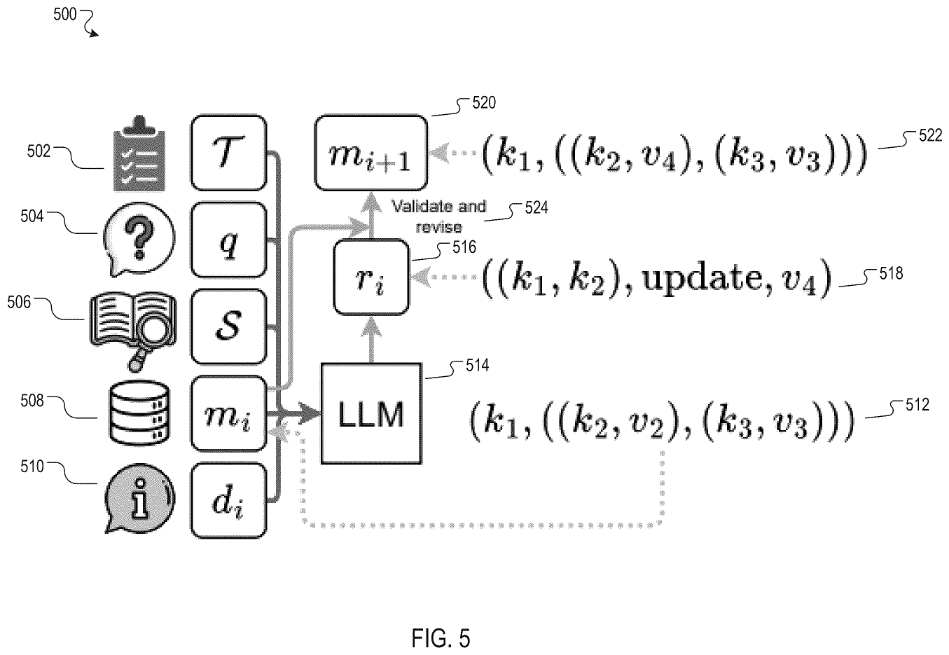

FIG. 5 illustrates an example 500 of performing a memory update iteration. The example 500 includes a generative neural network 514. The generative neural network 514 can process an input to generate a proposed memory update 516.

The input can include a task instruction 502, a query 504, a schema 506, a memory 508, and a current content chunk 510. The task instruction 502 characterizes the incremental task by providing specific details for the task to be performed. The query 504 specifies the goal or purpose of the incremental task. The schema 506 specifies the structure or organization of the structured memory.

The structured memory 508 can store data according to the schema. The structured memory 508 contains keys and values 512, represented as a hierarchical structure (k1, ((k2, v2), (k3, v3))). The hierarchical structure can organize information extracted from previously processed data chunks according to the schema 506. The keys, e.g., k1, k2, and k3, can represent different levels or categories within the hierarchy. For example, k1 could be a top-level category, while k2 and k3 can be sub-categories nested under k1. The values, e.g., v2 and v3, represent the specific data or information associated with their respective keys. This nested structure allows for complex relationships between different pieces of information to be represented in an organized way.

The current content chunk 510 is the current content chunk for the memory update iteration. The current content chunk 510 can represent a new segment of information, e.g., one of the content chunks 106a-c of FIG. 1, that has not yet been processed by the generative neural network 514. The system can process the current content chunk to extract relevant information to update the structured memory 508.

The proposed memory update 516 can specify a modification to the structured memory 508, e.g., replacing a value associated with a key. For example, as illustrated in FIG. 5, the proposed memory update 516 can specify an update operation 518 for the path (k1, k2) with a new value, the replacement value v4. This indicates that the value v2 associated with key k2 within the hierarchy under key k1 is to be updated with the value v4.

A validation engine 524 can validate, and if necessary, revise the proposed memory update 516. The validation engine 524 can receive the proposed memory update 516 and the structured memory 508 as inputs. The validation engine 524 can programmatically ensure that the proposed memory update 516 conforms to the expected structure specified by the schema 506. For example, the validation engine 524 can confirm that the path exists for an update operation or that a new value has the correct data type. If the proposed memory update 516 is valid, it can be applied to the structured memory 508 to generate an updated structured memory 520. If the proposed memory update 516 is not valid, the validation engine 524 can revise the proposed memory update before it is applied to the structured memory 508.

The updated structured memory 520 can reflect the incorporation of the proposed memory update 516. For example, as illustrated by the updated keys and values 522, the value v2 associated with the key k2 in the structured memory 508 can be replaced with the new value v4, resulting in the hierarchical structure (k1, ((k2, v4), (k3, v3))). The updated structured memory 520 can then serve as an input memory for a subsequent memory update iteration.

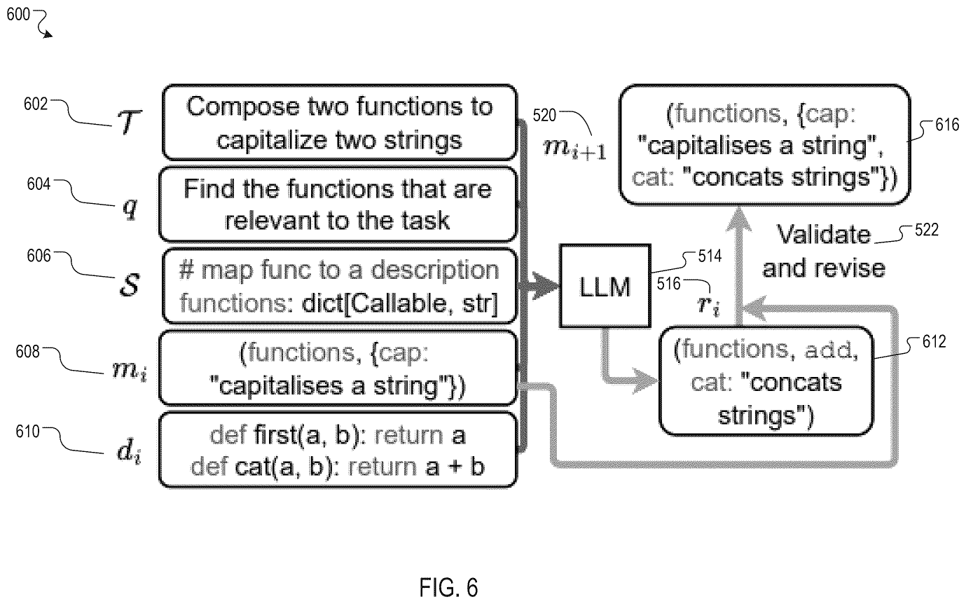

FIG. 6 illustrates an example 600 of performing a memory update iteration for a code composition task. The example 600 includes a generative neural network 514. The generative neural network 514 can process an input to generate a proposed memory update 516.

The input can include a task instruction 602, a query 604, a schema 606, a structured memory 608, and a current data chunk 610. For the code composition task, the task instruction 602 can be to “compose two functions to capitalize two strings.” The query 604 can be to “Find the functions that are relevant to the task.” The schema 606 can specify a dictionary mapping a function to its string description.

The structured memory 608 can contain a prior state of the functions dictionary. The prior state can include one function: (functions, {cap: ‘capitalises a string’}). The current data chunk 610 can include two new function definitions: def first (a, b): return a and def cat (a, b): return a+b.

The generative neural network 514 can process the query 604, the schema 606, the structured memory 608, and the current data chunk 610 to determine that the cat function is relevant to the task. The generative neural network can generate the proposed memory update 516 with an add operation and the replacement value 612, which is (functions, add, cat: ‘concats strings’), to add the new function and its description to the memory.

After the validation engine 524 validates the proposed update, an updated structured memory 520 can be generated. For example, as illustrated in updated values 616, the functions dictionary can include both the original cap function and the newly added cat function: (functions, {cap: ‘capitalises a string’, cat: ‘concats strings’}). The updated structured memory 520 can then be used in a subsequent memory update iteration or to generate a final response to the query.

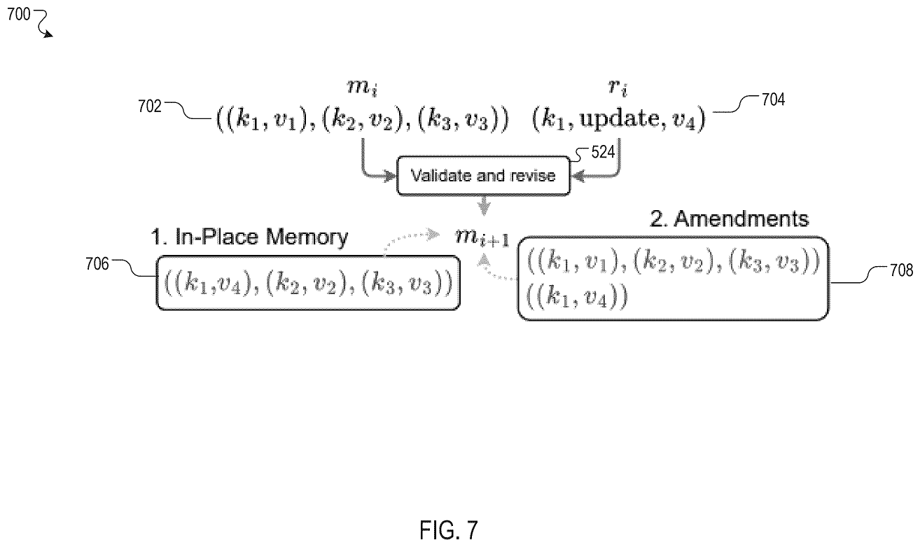

FIG. 7 illustrates an example 700 comparison between updating a structured memory by modifying values in the structured memory and by adding data to the end of the structured memory. The example 700 illustrates two approaches for updating a structured memory: an in-place memory update 706, and an amendment-based update 708.

A validation engine 524 can receive an initial structured memory 702, shown as ((k1, v1), (k2, v2), (k3, v3)), and a memory update 704, which can be an instruction to update the value associated with key k1 to v4. The memory update instruction can contain a path, an operation, and a value, specifying to update the value at key k/to the new value v4. This operation can be represented as (k1, update, v4).

For the in-place memory update 706, the value v/associated with key k1 can be directly replaced with the new value v4, resulting in an updated memory of ((k1, v4), (k2, v2), (k3, v3)). Since the memory is modified at the beginning of the structured data, the key-value cache cannot be reused for any part of the memory, and everything after the initial change needs to be re-encoded. Thus, for the in-place memory update 706, there is no matching prefix of the structured memory from the previous iteration that can be reused from the key-value cache. However, if the memory update specified a new value for key k3, the matching prefix would include the key k1 and k2 values.

For the amendment-based update 708, the original memory state is preserved, and the update ((k1, v4)) can be appended to the memory. The amendment-based approach can increase key-value cache utilization by ensuring the original memory structure remains as a matching prefix for subsequent iterations. The keys and values ((k1, v1), (k2, v2), (k3, v3)) can be preserved at the beginning of the updated memory. The entire original memory can be a part of a matching prefix. Therefore, the cached key-value data corresponding to this prefix can be reused from the previous iteration. This reuse can reduce the use of computational resources, by not re-encoding unchanged portions of the memory.

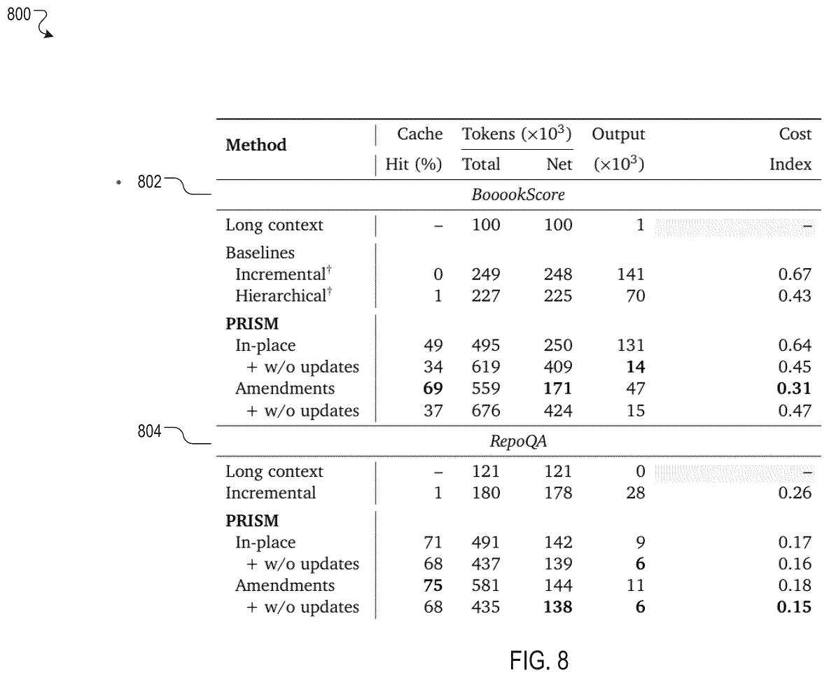

FIG. 8 shows a table 800 that includes performance metrics for various methods for performing two types of incremental tasks. The table 800 includes performance metrics for a long-document summarization task 802 and performance metrics for a code retrieval task 804. The performance metrics include “Cache Hit (%)”, total and net tokens processed (in thousands), output tokens (in thousands), and a “Cost Index.” The methods evaluated include a long context approach, baseline methods such as incremental approaches and hierarchical approaches, in-place updates to a structured memory as described in this specification, and an amendment-based approach as described in this specification.

The performance metrics for the long-document summarization task 802 illustrate that the amendment-based method of a response generation system, e.g., the response generation system 100 of FIG. 1, can achieve a high cache hit rate of 69% and the lowest cost index of 0.31, indicating improved efficiency compared to the baseline methods, which show cache hit rates of 0-1%. The net tokens processed by the amendment-based approach (171k) are substantially lower than those processed by baseline methods like incremental (248k) and hierarchical (225k) approaches. This reduction in net tokens processed, which represents the tokens that require new computation after accounting for cache hits, can reduce a computational load for each processing step.

The performance metrics for the code retrieval task 804 show that the present system can achieve high cache hit rates, with the amendment-based approach reaching 75%. In this case, the amendment-based approach can yield the lowest cost index (0.15) and the lowest net tokens processed. Overall, the table suggests that using the systems and techniques described in this specification for response generation, particularly using an amendment-based memory update strategy, can provide improvements in cache utilization and can reduce computational costs compared to baseline methods for incremental tasks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a query for an incremental task to be performed on a content item comprising a sequence of content chunks;
initializing a structured memory that represents data according to a schema; and
performing a respective memory update iteration for each content chunk in the sequence, each memory update iteration comprising:
processing an input for the memory update iteration comprising (i) the query, (ii) data specifying the schema, (iii) the structured memory as of the updating iteration, and (iv) the content chunk using a generative neural network to generate a proposed memory update; and
updating the structured memory using the proposed memory update; and
after performing the respective memory update iterations for the content chunks in the sequence, generating a response to the query using the structured memory.

2. The method of claim 1, wherein updating the structured memory using the proposed memory update comprises replacing a portion of the structured memory with the proposed memory update.

3. The method of claim 1, wherein updating the structured memory using the proposed memory update comprises adding the proposed memory update to the structured memory in accordance with the schema.

4. The method of claim 1, wherein each memory update iteration comprises storing keys and values representing the input in a key-value cache.

5. The method of claim 4, wherein processing an input for the memory update iteration comprises:
for each attention head of each attention layer of the generative neural network, accessing, from the key-value cache, keys and values for the attention head for a largest prefix of the input for the memory update iteration that has a matching prefix in the input for a previous memory update iteration.

6. The method of claim 5, wherein the largest prefix comprises the query, the data specifying the schema, and a portion of the structured memory after the previous memory update iteration.

7. The method of claim 5, wherein each memory update iteration further comprises after updating the structured memory, reordering the structured memory to prioritize data that is least likely to change during subsequent memory update iterations.

8. The method of claim 1, wherein the structured memory is ordered before the content chunk in the input.

9. The method of claim 8, wherein the query and the data specifying the schema are ordered before the structured memory in the input.

10. The method of claim 1, wherein the method further comprises receiving a task instruction characterizing the incremental task.

11. The method of claim 10, wherein the input further comprises the task instruction.

12. The method of claim 1, wherein the method further comprises generating the data specifying the schema.

13. The method of claim 12, wherein generating data specifying the schema comprises:
processing an input comprising the query using a second generative neural network to generate the data specifying the schema.

14. The method of claim 13, wherein the input comprising the query further comprises one or more examples that each include an example query and data specifying an example memory structure for responding to the example query.

15. The method of claim 1, wherein updating the structured memory using the proposed memory update comprises modifying one or more values in the structured memory using the proposed memory update.

16. The method of claim 1, wherein updating the structured memory using the proposed memory update comprises adding data specifying the proposed memory update to the end of the structured memory.

17. The method of claim 1, wherein the incremental task is a summarization task.

18. The method of claim 1, wherein the incremental task is a retrieval task.

19. A system comprising:
one or more computers; and
one or more storage devices communicatively coupled to the one or more computers, wherein the one or more storage devices store instructions that, when executed by the one or more computers, cause the one or more computers to perform operations comprising:
receiving a query for an incremental task to be performed on a content item comprising a sequence of content chunks;
initializing a structured memory that represents data according to a schema; and
performing a respective memory update iteration for each content chunk in the sequence, each memory update iteration comprising:
processing an input for the memory update iteration comprising (i) the query, (ii) data specifying the schema, (iii) the structured memory as of the updating iteration, and (iv) the content chunk using a generative neural network to generate a proposed memory update; and
updating the structured memory using the proposed memory update; and
after performing the respective memory update iterations for the content chunks in the sequence, generating a response to the query using the structured memory.

20. One or more non-transitory computer storage media storing instructions that when executed by one or more computers cause the one or more computers to perform operations comprising:
receiving a query for an incremental task to be performed on a content item comprising a sequence of content chunks;
initializing a structured memory that represents data according to a schema; and
performing a respective memory update iteration for each content chunk in the sequence, each memory update iteration comprising:
processing an input for the memory update iteration comprising (i) the query, (ii) data specifying the schema, (iii) the structured memory as of the updating iteration, and (iv) the content chunk using a generative neural network to generate a proposed memory update; and
updating the structured memory using the proposed memory update; and
after performing the respective memory update iterations for the content chunks in the sequence, generating a response to the query using the structured memory.
